(19) United States
(12) Patent Application Publication
(10) Pub. No.: US 2020/0288706 A1
(43) Pub. Date: Sep. 17, 2020

(54) COMPOSITES AND ARTICLES FOR THE SLOW RELEASE OF NON-POLAR VOLATILE LIQUID COMPOUNDS AND METHODS OF PREPARING

(71) Applicant: NEWSEAL MINERALS AND COATINGS LTD., RAMAT HASHARON (IL)

(72) Inventors: Yoram HASSON, RAMAT HASHARON (IL); Brian David COHEN, ASHKELON (IL)

(73) Assignee: NEWSEAL MINERALS AND COATINGS LTD., RAMAT HASHARON (IL)

(21) Appl. No.: 15/772,082

(22) PCT Filed: Oct. 28, 2016
(86) PCT No.: PCT/IL16/51168

§ 371 Date: Apr. 29, 2018

Related U.S. Application Data
(60) Provisional application No. 62/247,972, filed on Oct. 29, 2015.
(60) Provisional application No. 62/367,952, filed on Jul. 28, 2016.

(51) Int. Cl. A01N 25/18; A01N 65/00; A01N 53/00; A01N 61/00; A01N 25/02

(52) U.S. Cl. CPC A01N 25/18; A01N 65/00; A01N 25/02; A01N 61/00; A01N 53/00

(57) ABSTRACT

A composite for slow release of vapors from a non-polar liquid compound. The composite includes a hydrophobic material; and at least one volatile non-polar liquid compound associated with the hydrophobic material. The volatile non-polar liquid compound has a lower volatility after being associated with the hydrophobic material to form the composite.

### FIELD OF THE INVENTION

The present invention relates to a composite material for the slow release of vapors, which finds particular application in the slow release of non-polar volatile liquid compounds (e.g. plant extracted and essential oils). The invention further relates to methods of preparing the material and uses thereof.

### BACKGROUND OF THE INVENTION

Various volatile non-polar compounds may find practical application if their volatility (vaporization rate) could be controlled, in particularly if in a convenient product form and in commercially economic ways.

For example, certain plants and trees naturally produce oils (hydrocarbons) that exhibit a broad spectrum of activity against pest insects; bacteria; algae; nematodes and plant pathogenic fungi (collectively, hereinafter in the specification and claims: “pests”), and can act as an insecticidal, anti-feedant, repellent, oviposition deterrent, growth regulator and predator deterrent. These oils typically include low molecular weight oil fractions that are relatively volatile and which thus release an oil vapor. The oil vapor may drive off the insects and/or disrupt the activity or life-cycle of the insects, for example, confuse the insects, affect their metabolism or make them sterile.

The benefit of the slow release of essential oils or other such compounds can be understood as a result of various high academic studies and inventions designed to achieve such result. For example: BotanoCap Ltd., is the applicant or assignee of a number of patents and applications that disclose the preparation and use of encapsulated essential oils, for example in U.S. Pat. No. 9,210,926 (Markus, et al., 2014 Aug. 28); U.S. Pat. No. 8,753,676 (Kritzman, et al., 2014 Jun. 17); WO 2006/077568 (Markus, et al, 2006 Jul. 27); WO 2010/018576 (Markus, et al., 2010 Feb. 18); and WO 2016/051403 (Gezundhait, et al., 2016 Apr. 7), the contents of which are incorporated herein in their entirety.

### SUMMARY OF THE INVENTION

The present invention relates to a composite (composite material) for the slow release of non-polar volatile liquid compound(s)—i.e. the vapors/vaporization thereof. The composite may be prepared in a variety of forms, such as powder, aggregates (including sand, gravel and the like), particulates, minerals, wood chips, cloth/fabric (woven, non-woven), paper and other such cellulosic materials, fibers, and so on, including as an aerosol suspension.

The term “non-polar volatile liquid compound” and derivatives thereof, includes without limitation, natural and synthetic: oil; pheromones; alcohols; pyrethroids; and other hydrocarbons which can include alkanes, alkenes, alkynes, aldehydes, ketones, carboxylic acids—e.g. fatty acids; non-polar amino acids (e.g. alanine, valine, leucine, isoleucine, phenyl alanine, glycine, tryptophan, methionine and proline), including mixtures, derivatives and combinations thereof.

In some embodiments, the composite includes a packet, a sealed bag, a perforated bag, pouch, or container (hereinafter in the specification and claims “bag” or derivatives thereof), in which the mixture is housed.

The composite may have a wide variety of applications/implementations. Although the composite is particularly suited for agricultural applications, such as for insecticides, fungicides, algaecides, bactericides, herbicides, nematacides, acaracides, parasiticides, and the like, the applications are not necessarily limited to the aforementioned.

In accordance with embodiments of one aspect of the invention there is provided a composite for slow release of vapors from a non-polar liquid compound. The composite includes (a) a hydrophobic material; and (b) at least one volatile non-polar liquid compound operably associated (e.g. mixed) with the hydrophobic material to form the composite. The volatile non-polar liquid compound has a lower volatility after being associated with the hydrophobic material to form the composite.

In some embodiments, the hydrophobic material includes aggregates. In some embodiments, the hydrophobic material includes particulates. In some embodiments, the hydrophobic material includes minerals. In some embodiments, the hydrophobic material includes wood chips. In some embodiments, the hydrophobic material includes a cloth or fabric, including woven and non-woven. In some embodiments, the hydrophobic material includes paper. In some embodiments, the hydrophobic material includes fibers.

In some embodiments, the at least one volatile compound includes an essential oil; extracted plant oil; a fragrance oil, naturally occurring or synthetic, or any combination thereof. In some embodiments, the at least one volatile compound includes a 3-carbon or higher alcohol. In some embodiments, the at least one volatile compound includes a pheremone, naturally occurring or synthetic. In some embodiments, the at least one volatile compound includes a pyrethrin, naturally occurring or synthetic. In some embodiments, the liquid compound further includes a carrier oil. In some embodiments, the carrier oil includes paraffin oil. In some embodiments, the carrier oil includes canola oil. In some embodiments, the carrier oil includes paraffin oil. In some embodiments, the carrier oil includes vegetable oil; and in some embodiments includes a non-vegetable oil.

In some embodiments, the composite includes a bag that is permeable to the at least one volatile non-polar liquid compound. In some embodiments, the bag is a polyolefin bag. In some embodiments, the polyolefin bag includes a polyethylene material. In some embodiments, the polyolefin bag includes a polyester material. In some embodiments, the polyolefin bag includes a polyvinylidene material. In some embodiments, the polyolefin bag is made of polypropylene.

The effect of the composite, meaning the combination, integration, adsorption, absorption, mixing or bonding (hereinafter in the specification and claims “operable association”, “operably associated” or other such derivatives) of the non-polar liquid compounds with or without any carrier oil and the hydrophobic material (which herein the specification and claims includes hydrophobic coated materials), improves the delivery (implementation) of the compounds in that the composite can be formulated so that the rate of release (i.e. vaporization of the volatile fractions of the compounds) is in a range whereby the compounds are released (i.e. the volatile fractions thereof vaporize) at a high enough concentration/rate to be effective and yet at a slow enough rate so that the effect lasts long enough to be commercially viable, in some cases for weeks and even months.

The term “oils” and “oil” may be used interchangeably herein the specification and claims and it should be understood that the terms can relate to an oil having a variety of oil fractions (varied molecular constituents) and also a mixture of different oils, and may include plant-extracted oils, natural oils, essential oils, and synthetic oils.

In some embodiments, the composite may further include at least one additive selected from: insect growth regulators, insecticides, acaracides, fungicides, nematicides, and ectoparasiticides.

In some embodiments, the insecticides may be carbamates, ureas, triazines, triazoles, uracils, organophosphates, morpholines, dinitroanilines, acylalaninies, pyrethroids or organochlorines, including combinations thereof. Examples of the aforementioned include: carbofuran, azinphos-methyl, sulfentrazone, carfentrazone-ethyl, cypermethrin, cyromazine, beta-cyfluthrin, endosulfan, phosmet, chlorobromuron, chloroxuron, chlorotoluron, fluometuron, metobromuron, thiazafluoron, teflubenzuron, hexaflumuron, diflubenzuron, flufenoxuron, lufenuron, chlorfluazuron, novaluron. dimethachlor, metolachlor, pretilachlor, 2-chloro-n-(1-methyl-2-methoxyethyl)-acet-2,6-xylidide, alachlor, butachlor, propachlor, dimethenamid, bifenox, 4-(4-pentyn-1-yloxy)diphenylether, acifluorfen, oxyfluorfen, fluoroglycofen-ethyl, fomesafen, cis,trans-(+)-2-ethyl-5-(4-phenoxyphenoxymethyl)-1,3-dioxolane, fluazifop-butyl, haloxyfop-methyl, haloxyfop-(2-ethoxyethyl), fluorotopic, fenoxapropethyl, quizalofop-ethyl, propaquizafop, diclofop-methyl, butralin, ethalfluralin, fluchloralin, isopropalin, pendimethalin, profluralin, trifluralin. aclalanines furalaxyl, metalaxyl, benzoylprop ethyl, flamprop methyl, difenoconazole, etaconazol, propiconazole, 1,2-(2,4-dichlorophenyl)-pent-1-yl-1h-1,2,4-triazole, triadimefon, dioxacarb, furathiocarb, aldicarb, benomyl, 2-sec-butylphenylmethylcarbamate, etiofencarb, fenoxycarb, isoprocarb, propoxur, carbetamid, butylate, di-allat, eptc, molinate, thiobencarb, tri-allate, vemolate, piperophos, anilofos, butamifos, azamethiphos, chlorfenvinphos, dichlorvos, diazinon, methidathion, azinphos ethyl, azinphos methyl, chlorpyrifos, chlorthiofos, crotoxyphos, cyanophos, demeton, dialifos, dimethoate, disulfoton, etrimfos, famphur, flusulfothion, fluthion, fonofos, formothion, heptenophos, isofenphos, isoxathion, malathion, mephospholan, mevinphos, naled, oxydemeton methyl, oxydeprofos, parathion, phoxim, pyrimiphos methyl, profenofos, propaphos, propetamphos, prothiophos, quinalphos, sulprofos, phemephos, terbufos, triazophos, trichloronate, fenamipos, isazophos, s-benzyl-o,o-diisopropylphosphorothioate, edinphos, and pyrazophos, and combinations thereof.

In accordance with embodiments of another aspect of the invention there is provided a method of preparing a composite for a slow release of vapors from a non-polar liquid compound. The method includes (a) providing at least one volatile non-polar liquid compound; and (b) mixing the at least one volatile non-polar compound with a hydrophobic material. The method produces a composite in which the volatile non-polar liquid compound has a lower volatility after being associated with the hydrophobic material.

In some embodiments, step (a) further includes stirring a plurality volatile non-polar compounds. In some embodiments, the stirring is performed at room temperature. In some embodiments, step (b) includes mixing at room temperature. In some embodiments, the method includes placing the mixture in a permable bag that allows diffusion of the at least one volatile non-polar compound.

Herein the specification and claims, the term “mixing” is meant in the broadest sense and includes mixing in a mixer (blender); spraying or pouring of the non-polar volatile liquid compound on the hydrophobic material; shaking the compound and hydrophobic material together, and otherwise providing operably association, and so on.

In accordance with embodiments of another aspect of the invention there is provided an article for slow release of vapors from a non-polar liquid compound. The article includes a sealed permeable bag containing a volatile non-polar liquid compound.

In some embodiments, the article includes a non-hydrophobic material constituted by any one or combination of: powder, aggregates, particulates, minerals, wood chips, cloth/fabric, paper and other cellulosic materials, fibers.

In accordance with embodiments of yet another aspect of the invention there are provided uses of the aforementioned composite, including (separately or in combination) as an agricultural aid; an insecticide, a fungicide, a sprouting inhibitor and pest repellant. The composite can be used in agricultural/horticultural environments (both during soil preparation, during growth and post-harvest, the latter including shipping and storage) and other environments. Such other environments include in-door environments (e.g. homes, offices, factories, schools, hospitals, food storage sheds, etc.) and out-door environments (e.g. farms, gardens, nurseries, etc.). In addition, the implementations include, applying to surfaces by spraying, puffing, dusting, spreading adhering, etc., such as on walls, the fur of animals, and so on. Further, the composite can be used to treat wet environments (e.g. water reservoirs, ponds, lakes, swimming pools, aquariums, irrigation systems, outdoor items that collect rain such as discarded tires) to inhibit mosquitos and other pests, including wherein the composite is disposed in one or more permeable bags. The bags can be placed in the water, preferably submerged.

In some embodiments, the composite can be used as medicament or as an ingredient therein, for example as a dermatological product (anti-fungal), e.g. topical powder, ointment, cream, gel or the like. In some embodiments the aforementioned powder, ointment etc. can be used as a personal insect repellant.

### BRIEF DESCRIPTION OF THE DRAWINGS

The present invention will be understood and appreciated more fully from the following detailed description taken in conjunction with the appended drawings in which:

FIG. 1 is a schematic view of a composite in accordance with an embodiment of the present invention;

FIG. 2 is a schematic view of a composite in accordance with another embodiment of the present invention;

FIG. 3 is a schematic view of a composite in accordance with yet another embodiment of the present invention;

FIG. 4 is a schematic view of an article for the slow release of vapors in accordance with an embodiment of the present invention; and

FIG. 5 is a schematic view of the article for the slow release of vapors in accordance with another embodiment of the present invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DESCRIPTION OF EMBODIMENTS OF THE INVENTION

Illustrative embodiments of the invention are described below. In the interest of clarity, not all features/components of an actual implementation are necessarily described.

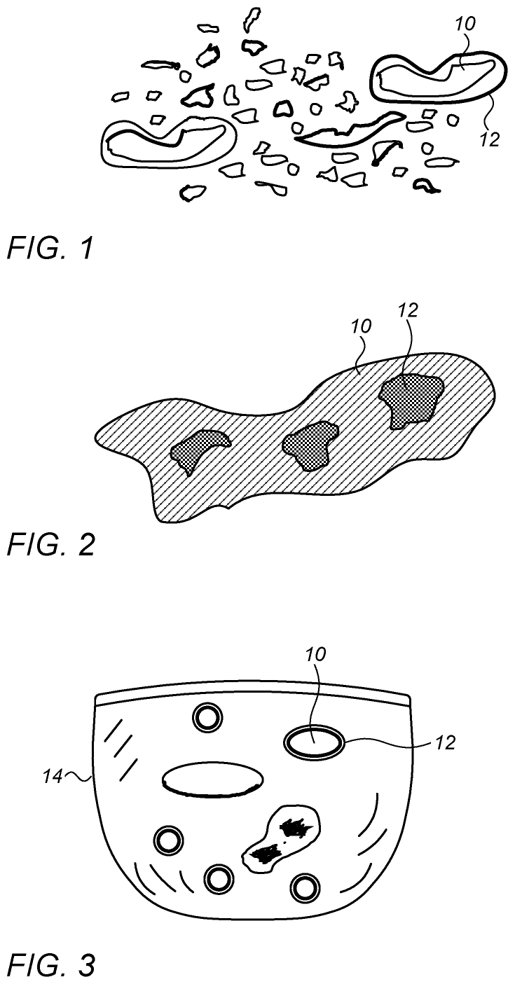

FIG. 1 shows an embodiment of the present composite including a hydrophobic material or hydrophobic coated material 10 and a volatile non-polar liquid compound 12 that is operably associated with (which includes any of: adsorbed onto, or absorbed into, bonded with, combined with, integrated with, adhered to, or the like) the hydrophobic material. In FIG. 1, hydrophobic material 10 is exemplified by a hydrophobic sand or aggregate.

In FIG. 2 the hydrophobic material 10 is exemplified by a hydrophobic cloth/fabric (woven or non-woven). In some embodiments, hydrophobic material 10 is, or includes any one or combination of: aggregates (including sand, gravel and the like), particulates, minerals, wood chips, cloth/fabric (woven, non-woven), paper, fibers, and so on; and packets/bags including any of the aforementioned within. In some embodiments, hydrophobic material 10 is, or includes, any one or combination of: powder, wood chips, particulates, minerals, paper, fibers, and so on.

FIG. 3 shows as embodiment wherein the composite further includes a permeable bag 14, housing the mixture of hydrophobic material 10 and volatile non-polar liquid compound 12.

In some embodiments, volatile non-polar liquid compound 12 includes one or a mixture of essential oils, alcohols (3-carbon and higher alcohols) and the like.

In some embodiments, volatile non-polar liquid compound 12 includes one or a mixture of carrier compounds, such as a carrier oil. Examples of carrier compounds include: paraffin oil, lanolin oil, canola oil, plant extracted oils such as olive oil, sunflower oil, avocado oil, coconut oil, palm oil and so on.

In some embodiments, the composite includes an adhesive (e.g. a double sided adhesive strip, wherein on one side of the strip there is adhered an aggregate composite or a cloth composite etc.), which can be a natural or synthetic adhesive, adapted to help the composite adhere to an item, such as the stem/stalk of a plant.

Preparing the composite by actively mixing the volatile non-polar liquid compound 12 and hydrophobic material 10, in a mixer/blender helps make the composite bond homogenous. However, liquid compound 12 can alternatively be sprayed on or shaken with hydrophobic material 10, or even merely combined, e.g. placed together in a bag (such as bag 14, FIG. 3), such as a polyolefin bag (e.g. PE, PP. LDPE, LLDPE, HDPE, HDPP, PET, polyester, polyvinylidene chloride) a container with at least a portion that allows diffusion of vapors from the composite. The diffusion rate of the vapors is a function of the particular liquid compound (e.g. oil or oils used) type of hydrophobic material (e.g. aggregate, sand, etc., or combination thereof) and the thickness and diffusivity of the bag/container material, if any.

Without limitation to theory, it is believed that there is a particular chemical/physical attraction between non polar volatile liquid compound 12 (in particular volatile fractions thereof) and hydrophobic material 10, such that the volatile compound 12 is less volatile than if the compound were in “free” form, for example not chemically associated with, combined with, or bonded to the hydrophobic material.

Again, without limitation to theory, it is believed that the aforementioned chemical/physical attraction is a non-covalent attraction or bonding.

The aforementioned attraction or bonding has been found to be effective to result in a slow release of volatile compound 12 in a range of vaporization rates such that the composite (as a “vehicle” for the vapor emanating therefrom) can be suitable for a wide variety of applications. A particularly useful application is in the field of agriculture, in pre-harvesting, during growth and post-harvesting, to prevent damage from a wide variety of pests and/or retard sprouting (e.g. on potatoes and sweet potatoes). It is expected that the instant composites may have many additional useful applications.

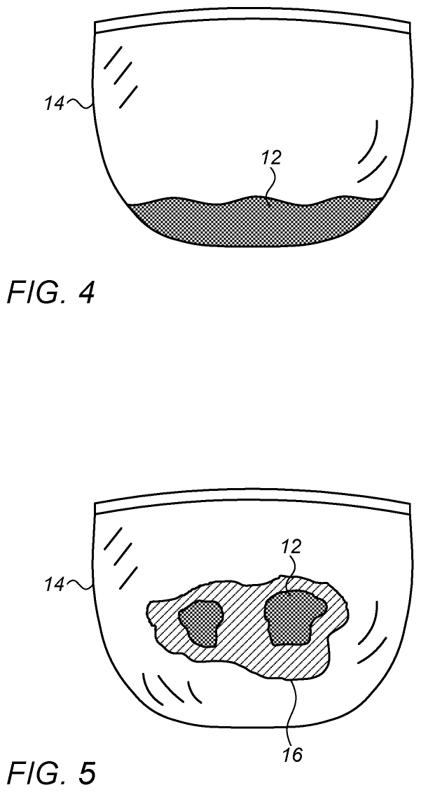

FIG. 4 shows an article for the slow release of vapors in accordance with embodiments of the present invention wherein the article includes (sealed) permeable bag 14 containing volatile non-polar liquid compound 12. In essence, the article of FIG. 4 can be thought of as a simplified version of the composite of FIGS. 1-3 wherein there is no hydrophobic material 10.

FIG. 5 shows an article for the slow release of vapors in accordance with embodiments of the present invention, which also can be considered as a simplified version of the composite of FIGS. 1-3 wherein there is no hydrophobic material 10. Here, the article is as in FIG. 4, however, contained in bag 14 is non-hydrophobic material 16, which can be any one of or combination of non-hydrophobic: powder, aggregates (including sand, gravel and the like), particulates, minerals, wood chips, cloth/fabric (woven, non-woven), paper and other such cellulosic materials, fibers, and so on. Non-hydrophobic material 16 has associated therewith volatile non-polar liquid compound 12.

### EXAMPLES

All steps in the following examples were performed at room temperature.

### Example No. 1

Protecting cupboards from cockroaches: 3 grams of each of the essential oils: cinnamon, clove and eucalyptus were poured slowly into a beaker and stirred, at room temperature. The mixture of essential oils was added to and stirred in a beaker with 20 grams of Canola oil (carrier oil) until all the oils were fully homogeneous (about 2 minutes). The resultant homogenous oil mixture was then slowly added to a mixer with 100 grams of hydrophobic Vermiculite and mixed for about 2 minutes, at room temperature, until homogeneous. The mixed product was placed in a permeable polyethylene bag, whereby oil vapor could pass/diffuse. For storage purposes, the polyethylene bags can be stored in impervious containers (such as 3 layers of silver laminated film packet) to stop the process of fumigation until needed.

### Example No. 2

Protecting flowerpots and window boxes from ants: 4 grams of each of the essential oils Cinnamon and Clove; and 2 grams of Peppermint were poured slowly into a beaker and stirred with 20 grams of Paraffin oil (carrier oil) until the oils were fully homogeneous. The homogenous oil mixture was then slowly added to a mixer with 1 kilo of hydrophobic sand (Newseal Minerals and Coatings Ltd, Ramat Hasharon, Israel) and mixed for about 2 minutes until homogeneous. As noted above, the mixed product can be placed in impervious containers (such as 3 layers of silver laminated film packet) to stop the process of fumigation until needed. The product can be sprinkled on the soil in the flowerpot.

### Example No. 3

Protecting dogs from fleas and ticks: 30 grams of lavender essential oil poured slowly into a mixer with 1 kilo of hydrophobic micron Calcium Carbonate powder. The mixer was turned on and the Lavender oil mixture was slowly added to the calcium carbonate and mixed for about 2 minutes until homogeneous. The mixed product was placed in impervious containers (such as 3 layers of silver laminated film packet) as to stop the process of fumigation until needed. The packet can be opened and the powder sprinkled or puffed on the dog fur and rubbed in.

### Example No. 4

Potato sprouting inhibitor: 40 grams of Peppermint essential oil was poured slowly into a mixer with 100 grams of hydrophobic Vermiculite (Newseal Minerals and Coatings Ltd, Ramat Hasharon, Israel) and mixed for about 2 minutes until homogeneous. The mixed product was placed in 10 permeable polyethylene bags allowing vapor passage, which were then placed in impervious containers (such as 3 layers of silver laminated packets) to stop the fumigation process until needed. To use, open the laminated packets and place the polyethylene bags in a container storing the potatoes.

### Example No. 5

Protecting plants from Aphids: 4.5 grams of thyme essential oil, 1.7 grams of anise essential oil, 1.8 grams lavender essential oil, 1.9 grams lemon eucalyptus and 0.7 grams peppermint essential oil were poured slowly into a beaker and stirred. The essential oil mixture was then poured into a beaker with 23 grams of Paraffin oil (carrier oil) and stirred until the oils were fully homogeneous (about 2 minutes). The resultant oil mixture was then slowly added to a mixer with 1 kilo of hydrophobic calcium carbonate micron powder and mixed for about 2 minutes until homogeneous. The product can be placed in impervious containers (such as 3 layers of silver laminated film packet) as to stop the process of fumigation until needed. The packet can be opened and the contents poured into a puffer/dusting apparatus to puff the plants.

### Example No. 6

Protecting cupboards/closets from Moths: 1.3 grams of each of the following essential oils: Patchouli, Cinnamon, Peppermint and Cedar were poured slowly into a stirred beaker with 12 grams of paraffin oil (carrier oil) for about 2 minutes until the oils are fully homogeneous. The resultant oil mixture was then slowly poured into a mixer with 500 grams of hydrophobic sand and mixed for about 2 minutes until homogeneous. The mixed product was placed in a permeable polyethylene bag allowing vapor passage, and then placed in an impervious container (such as 3 layers of silver laminated film packet) to stop the process of fumigation until needed. To use, the packet us opened and the polyethylene bags can be placed in the food/clothes cupboard.

### Example No. 7

Protecting water ponds from mosquitoes: 40 grams of turmeric essential oil was slowly poured into a mixer with 1 kilo of hydrophobic sand and mixed for about 2 minutes until homogeneous. The mixed product can be placed in a permeable polyethylene bag allowing vapor passage and then placed in impervious containers (such as 3 layers of silver laminated film packet) to stop the fumigation process until needed. The polyethylene bags can be put in the pond whereby the active ingredients of the turmeric diffuse into the water and will disrupt life cycle of the mosquitoes.

### Example No. 8

Insect attraction (Attracting the Red Palm Weevil from harming the Palm trees): 4 grams of male produced aggregation pheromone oil (4-Methyl-5-Nonanol and 4-Methyl-5 Nonanone) was slowly poured into a mixer with 100 grams of hydrophobic sand and mixed for about 2 minutes until homogeneous. The mixed product was placed in a permeable Polyethylene bag allowing vapor passage and then placed in impervious containers (such as 3 layers of silver laminated film packet) to stop the process of fumigation until needed. To use, open the packet and place the Polyethylene bag at least 20 meters from the nearest Palm tree to attract and trap the beetles. Alternatively, the sand/pheromone mixture can be sprinkled on the ground.

### Example No. 9

Component A—Insect attraction and harming (attracting the Red Palm Weevil). 4 grams of male produced aggregation pheromone oil (4-Methyl-5-Nonanol and 4-Methyl-5 Nonanone) was slowly poured into a mixer with 100 grams of hydrophobic calcium carbonate powder and mixed for about 2 minutes until homogeneous.

Component B—Pyrethroid or Pyrethrum insecticides in a non-polar liquid form. 8 grams of one of Pyrethrum insecticide, was slowly poured into a mixer with 10 grams of hydrophobic Vermiculite and mixed for about 2 minutes until homogeneous.

Component C—Pyrethrum insecticide in a powder form (an alternative to the liquid form).

Component A and component B were mixed in a mixer for about 1 minute and then placed in impervious containers (such as 3 layers of silver laminated film packet) to stop the process of fumigation until needed. To use, the packet contents can be poured/placed at least 20 meters from the nearest Palm tree to attract and trap the weevils.

Component A and Component C were mixed in a mixer for about 1 minute and then placed in impervious containers (such as 3 layers of silver laminated film packet) to stop the process of fumigation until needed. To use, the packet contents can be poured/placed at least 20 meters from the nearest Palm tree to attract and trap the weevils.

### Example No. 10

Protecting potted plants from insects: 40 grams of cold-pressed turmeric oil was slowly poured onto a 1 square meter sheet of hydrophobic nonwoven polypropylene cloth (e.g. such as sold by 3M) resulting in a non-saturated nonwoven cloth product. The product was placed in an impervious container. To use, the cloth sheet product can be placed vertically along the stem/stalk of the plant.

### Example No. 11

Protecting fruits from fungus: 1 gram of each one of the following essential oils: thyme, cinnamon and citronella were poured slowly into a beaker and stirred for about 1 minute, until homogeneous. The oil mixture was then poured into a beaker with 6 grams of Canola oil (carrier oil) and stirred for about 2 minute until the oils were fully homogeneous. The resultant oil mixture was slowly poured onto a 1 square meter sheet of hydrophobic coated paper/cardboard, producing a less than saturated sheet product. The paper/cardboard product was placed in a permeable polyethylene bag allowing vapor passage and then placed in an impervious container. The polyethylene bag can be opened and placed in the fruit box.

### Example No. 12

Bonding and slow release of long chain alcohols: n-Butanol (C₄H₉OH) was poured slowly into a mixer with 100 grams of hydrophobic vermiculite and mixed for about 2 minutes until homogeneous. The mixed product was placed in a permeable polyethylene bag and then in an impervious container. The bag can be placed in the fruit box as a fungicide protection.

### Example No. 13

Algaecide: 4 grams of turmeric essential oil was slowly poured into a mixer with 100 grams of hydrophobic sand and mixed for about 2 minutes until homogeneous. The mixed product was placed in a permeable polyethylene bag and then in an impervious container. The bag can be placed in a pond, lake, etc., and will inhibit algae growth.

### Example No. 14

Fragrance: 4 grams of Rose fragrance synthesised essential oil was slowly poured into a mixer with 100 grams of hydrophobic coated micron calcium carbonate and mixed for about 2 minutes until homogeneous. The resultant mixture was placed in a permeable polyethylene bag and then in an impervious container. The bag can be placed in a room/bathroom for providing a fresh fragrance.

It will be appreciated that the above description is intended only to provide examples, and that many other embodiments are possible within the scope of the present invention and as defined in the appended claims.

1. A composite for release of vapors from a non-polar liquid compound, the composite comprising:
a hydrophobic material; and
at least one volatile non-polar liquid compound operably associated with said hydrophobic material to form said composite,
wherein said at least one volatile non-polar liquid compound is a plant extracted compound or an essential oil and the composite is configured to slow the rate of the release of the vapors while still at a rate in a range effective for repelling insects and/or mitigating food sprouting.

2. The composite of claim 1, wherein the hydrophobic material comprises aggregates.

3. The composite of claim 1, wherein the hydrophobic material comprises particulates.

4. The composite of claim 1, wherein the hydrophobic material comprises minerals.

5. The composite of claim 1, wherein the hydrophobic material comprises wood chips.

6. The composite of claim 1, wherein the hydrophobic material comprises a cloth or fabric, including woven and non-woven.

7. The composite of claim 1, wherein the hydrophobic material comprises paper.

8. The composite of claim 1, wherein the hydrophobic material comprises fibers.

9. The composite of claim 1, wherein said at least one volatile compound comprises an essential oil; extracted plant oil; a fragrance oil, naturally occurring or synthetic, or any combination thereof.

10. The composite of claim 1, wherein said at least one volatile compound comprises a 3-carbon or higher alcohol.

11. The composite of claim 1, wherein said at least one volatile compound comprises a pheremone, naturally occurring or synthetic.

12. The composite of claim 1, wherein said at least one volatile compound comprises a pyrethrin, naturally occurring or synthetic.

13. The composite of claim 1, wherein the liquid compound further comprises a carrier oil.

14. The composite of claim 13, wherein the carrier oil comprises a non-vegetable oil.

15. The composite of claim 13, wherein the carrier oil comprises paraffin oil.

16. The composite of claim 13, wherein the carrier oil comprises canola oil.

17. The composite of claim 1, further comprising a bag that is permeable to said at least one volatile non-polar liquid compound.

18. The composite of claim 17, wherein said bag is a polyolefin bag.

19. The composite of claim 18, wherein said polyolefin bag comprises a polyethylene material.

20. (canceled)

21. (canceled)

22. The composite of claim 18, wherein said polyolefin bag is made of polypropylene.

23-29. (canceled)
